(19) United States
(12) Patent Application Publication
(10) Pub. No.: US 2019/0268143 A1
(43) Pub. Date: Aug. 29, 2019

(54) USING SECURED IMAGE OR PHOTO DATA FOR MOBILE PAYMENT APPLICATIONS

(71) Applicant: Michael ALexander, Rockwall, TX (US)

(72) Inventor: Michael ALexander, Rockwall, TX (US)

(21) Appl. No.: 15/663,933

(22) Filed: Jul. 31, 2017

(51) Int. Cl. H04L 9/08; H04L 9/32; G06F 21/60; G06Q 20/32

(52) U.S. Cl. CPC H04L 9/0825; G06Q 20/3227; G06F 21/602; H04L 9/3247

(57) ABSTRACT

An image or photo on a smart device is encrypted and transmitted to a PCI compliant server during a negotiation with a client. The encrypted data received is broken in a Public Key and a Private Key on the PCI compliant server. The public key is sent back to the smart device as encrypted data. The public key encrypted data encapsulates the data into a public key portion of the data is transmitted back to the device for inclusion of Personal Sensitive Information data on the smart device, prepares the data for transmission, and transmits the data back to the PCI compliant server via secured web services for decryption. The private key residing on the PCI compliant server decrypts the incoming encrypted personal sensitive information to multiple secured databases located across multiple server farms.

### CROSS-REFERENCES IO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

### 1. Technical Field

The present disclosure relates to systems and methods for mobile payment applications, and more particularly, to encryption of smart device photo data combined with identification numbers in stored in locations for use in financial operations.

### 2. Background

Payment transactions and other financial operations may be implemented using a smart phone or other computerized hardware device. The device may be used for transactions at a point of sale (POS) over a wireless communications channel. A transaction generally requires protection of personal sensitive information (PSI). A user may set a personal identification number (PIN) when first configuring the payment mechanism associated with the device to protect the PSI. While use of a mobile payment system at the point of sale is generally quite short, the transaction is delayed when a navigate the mobile payment application. There is a need in the art for a smart device on which a user can to take u picture or select an image from a photo gallery and encrypt that image as data tor use in mobile negotiations.

### SUMMARY

In certain example embodiments described herein, methods and systems secure an image or photo from a smart device for use in mobile payment applications. Image data is sent to a PCI server that divides and encrypts the data. A public key portion of the data is sent back to the device for inclusion of Personal Sensitive Information data from the device. A private key portion of personal data remains residing on the PCI server. The smart device includes personal account information and transmits that data back to the PCI compliant server via secured web services for decryption by a private key. The private key data decrypts the incoming PSA data from the smart device. The server then transmits the data to a database secured with encrypted login and passwords.

### BRIEF DESCRIPTION OF THE SEVERAL VIEWS OF THE DRAWINGS

FIG. 1 is a block diagram 100 depicting steps of a mobile smart device image generation or stored photo retrieval 110, reduction of the data to an encrypted format by the application 120, and transmission of the data to a server 130, in a mobile transaction system in accordance with one or more of the embodiments herein. The mobile smart device may be a mobile phone, smartphone, handheld computer, personal digital assistant (PDA), netbook computer, laptop computer, tablet computer, or similar wired or wireless, processor-driven device.

FIG. 2 is a block diagram 200 depicting steps of the server breaking down the encrypted data into two components 210, retaining one portion on the server 220 and transmitting the other portion to the smart device 230, in a mobile transaction system in accordance with one or more of the embodiments herein.

FIG. 3 is a block diagram 300 depicting steps of the smart device combining one portion with information 310 and streaming that data to the server 320, where the retained private key decrypts and distributes the information to a database 330 in accordance with one or more of the embodiments herein.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

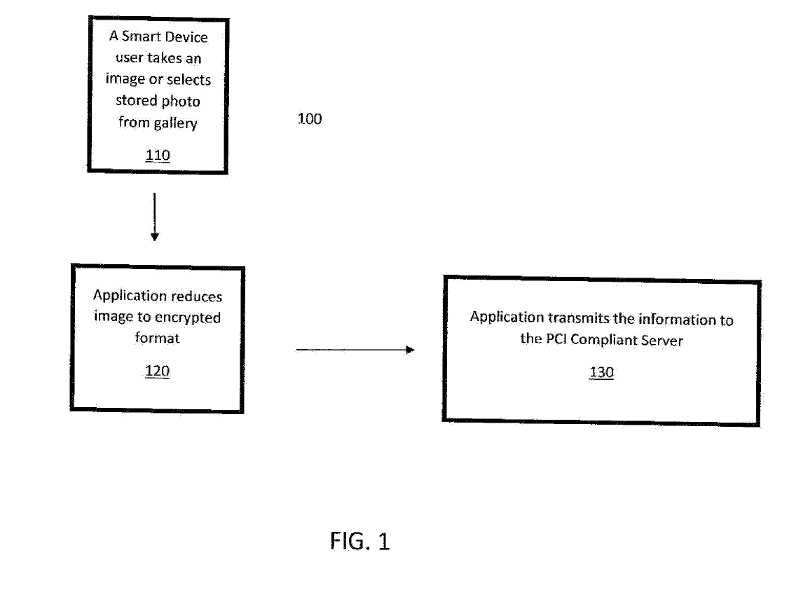

The invention described herein is a smart device application. The application enables use of the smart device to take an image or retrieve a photo from the smart device gallery for use in immediate mobile payment applications. FIG. 1 is a block diagram displaying the first steps of using the smart device for taking an image or selecting a photo. The image or photo data is reduced to an encrypted format by the application and is transmitted to a PCI-Compliant server.

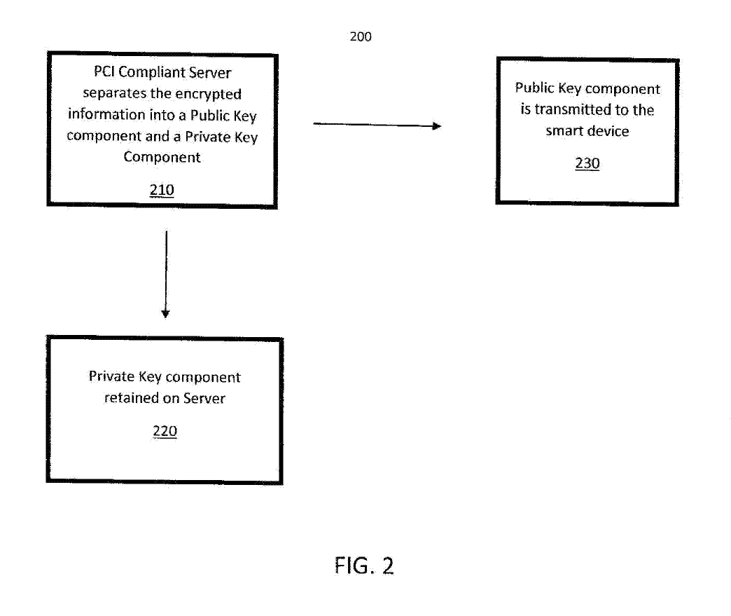

FIG. 2 displays the steps of the server dividing the data into two components. A Public Key component is formed and transmitted to the smart device. A Private Key component is retained on the server.

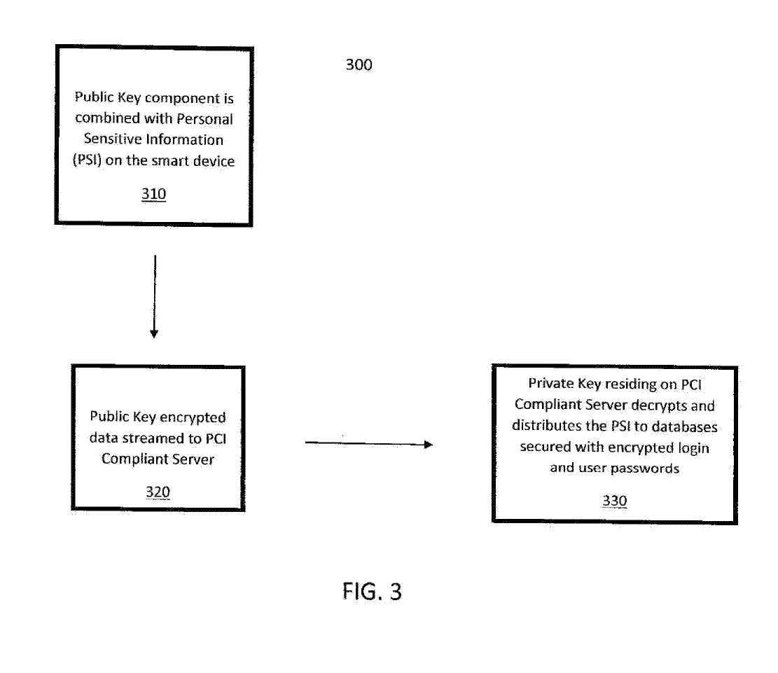

FIG. 3 depicts the steps of the application on the smart device combining Public Key information with the user's Personal Sensitive Information (PSI) on the smart device. The application performs and undergoes the identification, authentication, payment credential verification, and storage. That encrypted data is then transmitted back to the server. The Private Key data component residing on the server decrypts the incoming data. The server distributes the information to the appropriate database. Each database is secured with the encrypted login and user password. The user can enter the password or login each of the components can be recovered from their respective database locations.

In conclusion, the present invention has assuredly achieved anticipated effectiveness, moreover, contents of the present invention have not been publicly disclosed prior to this application, and novelty, advancement and industrial practicability of the present invention clearly comply with essential elements as required for a new patent application. Accordingly, a new patent application is proposed herein.

1. A computer-implemented method, comprising:
obtaining an image with a computer device;
reducing said image to an encrypted data format;
sending said data to a server;
separating said data into a public key and a private key,
whereby said public key data is returned to said device, generating a secure shell identification string that comprises said encrypted data; transmitting the generated identification string to another computer system for decryption; and,
whereby said private key decrypts said encrypted identification string exchange; receiving, from the other computer system, after an authentication request that comprises a digital signature; transmitting to the authentication service the digital signature and information usable to a set of secured databases located across multiple servers.
